(19) United States
(12) Patent Application Publication
(10) Pub. No.: US 2005/0206680 A1
(43) Pub. Date: Sep. 22, 2005

(54) Fluid injector devices and fabrication methods thereof

(75) Inventors: Wei-Lin Chen, Taipei (TW); Hung-Sheng Hu, Kaohsiung (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BenQ Corporation

(21) Appl. No.: 11/079,066

(22) Filed: Mar. 14, 2005

(30) Foreign Application Priority Data
Mar. 17, 2004 (TW) 93107059

(51) Int. Cl. B41J 2/14

(52) U.S. Cl. 347/48

(57) ABSTRACT

Fluid injection devices and fabrication methods thereof. The fluid injection device comprises a substrate, a structural layer disposed on the substrate, a fluid created between the substrate and the structural layer, and at least one bubble generator disposed on the structural layer and on the opposite side of the fluid chamber. A passivation layer is disposed on the structural layer covering the bubble generator. A composite layer is formed on the passivation layer. A nozzle neighboring the bubble generator is formed passing through the composite layer, the passivation layer, and the structural layer, communicating with the fluid chamber.

### BACKGROUND

The invention relates to fluid injector devices and fabrication methods thereof, and more particularly, to fluid injector devices with high injection performance and prolonged lifetime and fabrication methods thereof.

Typically, fluid injectors are employed in inkjet printers, fuel injectors, biomedical chips and other devices. Among inkjet printers presently known and used, injection by thermally driven bubbles has been most successful due to its reliability, simplicity and relatively low cost.

FIG. 1 is a cross section of a conventional monolithic fluid injector 1 disclosed in U.S. Pat. No. 6,102,530, the entirety of which is hereby incorporated by reference. A structural layer 12 is formed on a silicon substrate 10. A fluid chamber 14 is formed between the silicon substrate 10 and the structural layer 12 to receive fluid 26. A first heater 20 and a second heater 22 are disposed on the structural layer 12. The first heater 20 generates a first bubble 30 in the chamber 14, and the second heater 22 generates a second bubble 32 in the chamber 14 to inject the fluid 26 from the chamber 14.

Conventional monolithic fluid injectors using a bubble as a virtual valve are advantageous due to reliability, high performance, high nozzle density and low heat loss. As inkjet chambers are integrated in a monolithic silicon wafer and arranged in a tight array for high device spatial resolution, no additional nozzle plate is needed to assembly.

The structural layer 12 of the conventional monolithic fluid injector 1 comprises low stress silicon nitride. However, the lifetime of the injector 1 is critically determined by thickness of the structural layer. Moreover, the droplet may deviate from the desired direction due to insufficient thickness of the structural layer. Additionally, since heaters 21, 22 are located on the structural layer, the heat to generate bubble by the heater 22, 23 may pass through the structure layer into the chamber, causing crosstalk and disturbing operating frequency.

It is therefore important to provide a fluid injector capable of effectively dissipating heat and having a strengthened structural layer. Conventionally, a metal layer on the structural layer conducts and dissipates residual heat effectively and strengthens the structural layer. However, the surface characteristic of the metal layer cannot meet requirements of fluid injector applications.

### SUMMARY

Fluid injector devices and fabrication methods thereof are provided by employing a composite layer comprising of a metal layer and a hydrophobic polymer layer to improve injection performance as well as prolong lifetime.

Some embodiments of the invention provide a fluid injection device, comprising a substrate, a structural layer disposed on the substrate, a fluid chamber between the substrate and the structural layer, at least one bubble generator disposed on the structural layer and on the opposite side of the fluid chamber, a passivation layer on the structural layer covering the bubble generator, a composite layer on the passivation layer, and a nozzle neighboring the bubble generator and passing through the composite layer, the passivation layer, and the structural layer communicating with the fluid chamber.

Some embodiments of the invention provide a method for fabricating a fluid injection device, comprising providing a substrate, forming a patterned sacrificial layer on the substrate, forming a patterned structural layer on the substrate covering the sacrificial layer, forming at least one fluid actuator on the structural layer, forming a passivation layer on the structural covering the fluid actuator, forming a composite layer on the passivation layer, removing a portion of the bottom of the substrate creating a fluid channel in the substrate and exposing the sacrificial layer, removing the sacrificial layer to form a fluid chamber, and sequentially etching the composite layer, the passivation layer, and the structural layer to create a nozzle neighboring the fluid actuator communicating with the fluid chamber.

### DESCRIPTION OF THE DRAWINGS

The invention can be more fully understood by reading the subsequent detailed description in conjunction with the examples and references made to the accompanying drawings, wherein:

FIG. 1 is a schematic view of a conventional fluid injection device;

FIG. 2 is a cross section of a fluid injector according to embodiments of the invention;

FIGS. 3A to 3D are cross-sections of the process of manufacturing a fluid injection device according to the first embodiment of the invention;

FIGS. 4A to 4E are cross-sections of the process of manufacturing a fluid injection device according to the second embodiment of the invention;

FIGS. 5A to 5D are cross-sections of the process of manufacturing a fluid injection device according to the third embodiment of the invention; and

FIGS. 6A to 6E are cross-sections of the process of manufacturing a fluid injection device according to the fourth embodiment of the invention.

### DETAILED DESCRIPTION

FIG. 2 is a cross section of a fluid injector 100 according to one embodiment of the invention. The fluid injector 100 comprises a base 110 having a fluid chamber 113 in a substrate 111, a structural layer 112 disposed on the substrate, at least one bubble generator 120, such as heater formed on the structural layer, and a passivation layer 130 disposed on the structural layer covering the bubble generator 120. A hydrophobic and thermal dissipation composite layer comprising a metal layer 140 and polymeric layer 150 is disposed on the metal layer 140. A nozzle is created through the composite layer, the passivation layer 130 and structural layer 112, communicating with the chamber.

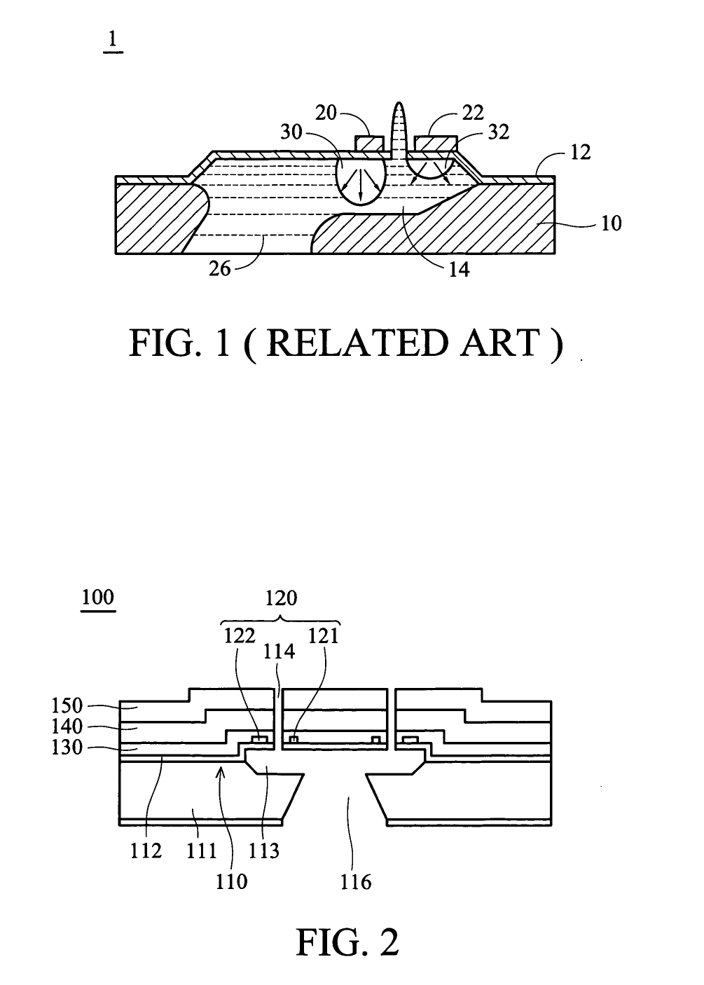

The bubble generator 120 is disposed on the structural layer 112. The bubble generator 120 comprises at least one resistive heater. In the illustrated embodiment, the bubble generator 120 may also comprise a first heater 121 and a second heater 122. The first heater 121 generates a first bubble 30 (as shown in FIG. 1) in the chamber 113, and the second heater 122 generates a second bubble 32 (as shown in FIG. 1) in the chamber 113 to inject the fluid from the chamber 113.

The fluid injector 100 may also comprise a signal transmitting circuit (not shown) disposed between the structural layer 112 and passivation layer 130 and formed by physical vapor deposition (PVD) a patterned conductive layer, such as aluminum (Al), copper (Cu), Al—Cu alloy, or other conductive materials.

The passivation layer 130 comprising low stress silicon oxynitride (SiON) is disposed on the structural layer 112. The residual stress of the passivation is in a range of about 100-200 MPa.

The metal layer 140 may be disposed on the passivation layer 114. Note that the metal layer 140 may comprise Ni, N—Co alloy, Au, Au—Co alloy or combinations thereof. The metal layer 140 may preferably comprise thermally conductive materials. The hydrophobic polymer layer 150 such as polymeric layer is disposed on the metal layer 140. The hydrophobic polymer layer 150 may comprise polyimide, photosensitive polymer and/or silicone.

The nozzle 114 neighboring the bubble generator 120 passes through the hydrophobic polymer layer 150, the metal layer 140, the passivation layer 130 and the structural layer 120, communicating with the fluid chamber 113.

### First Embodiment

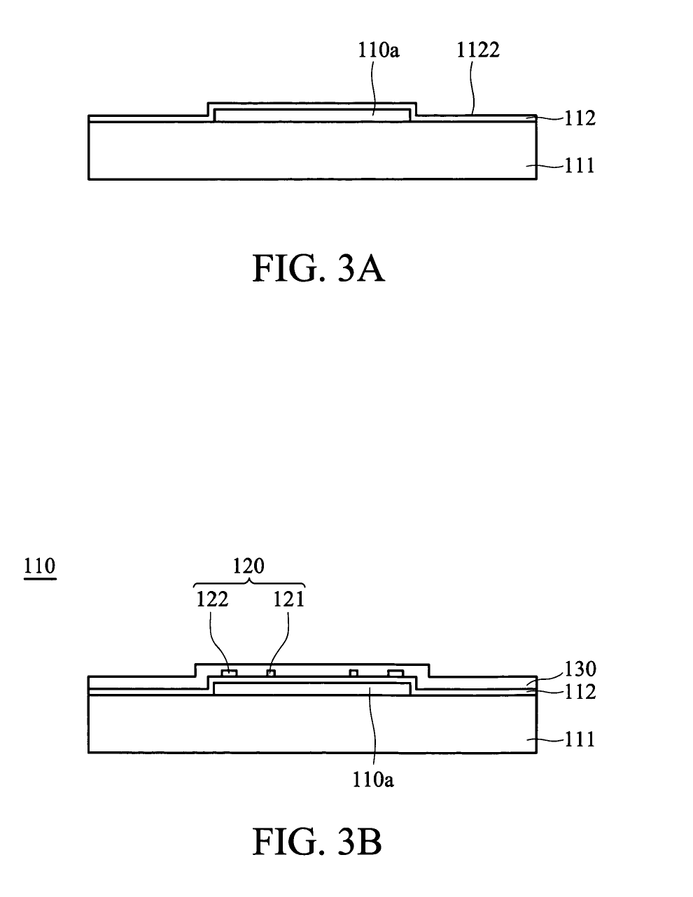

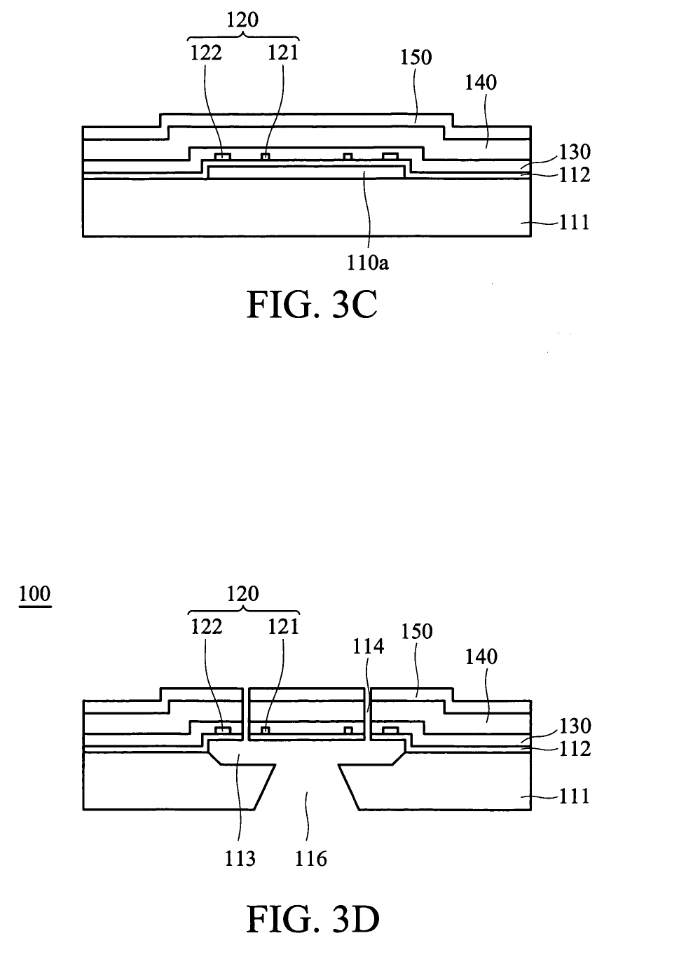

FIGS. 3A-3D are cross-sections of the process of manufacturing a fluid injection device according to the first embodiment of the invention.

Referring to FIG. 3A, a patterned sacrificial layer 111a is formed on a substrate 111 (e.g., a silicon wafer). The sacrificial layer 111a comprises silicon oxide at a thickness between about 1500 Å to 2000 Å. The sacrificial layer 111a may be deposited using a CVD or LPCVD process. Next, a patterned structural layer 112 is conformably formed on the substrate 111 covering the sacrificial layer 111a. The structural layer 112 comprises low stress silicon nitride or silicon oxynitride (SiON) deposited using a CVD or LPCVD process.

Referring to 3B, at least one fluid actuator 120 such as a bubble generator 120 is formed on the structural layer 112. The bubble generator 120 is formed by a resistive layer, preferably comprising HfB₂, TaAl, TaN, or TiN. The bubble generator 120 may be deposited using a PVD process, such as evaporation, sputtering, or reactive sputtering.

A passivation layer 130 is formed on the structural layer 112 covering the bubble generator 120. The passivation layer 130 comprises low stress silicon nitride deposited by CVD or LPCVD.

Referring to FIG. 3C, a metal layer 140 is formed on the passivation layer 130. The metal layer 140 comprises Ni—Co alloy, Au—Co alloy and/or Au deposited by electro-forming, electroless plating physical vapor deposition or chemical vapor deposition. A hydrophobic polymer layer 150 such as a polymer layer is subsequently formed on the metal layer 140. The hydrophobic polymer layer 150 comprises polyimide, photosensitive polymer, or silicone applied by spin-on coating printing, and/or rolling.

Referring to FIG. 3D, the back of the substrate 111 is etched forming a fluid channel 116 in the substrate 111 and exposing the sacrificial layer 111a. The sacrificial layer 111a is removed, forming a fluid chamber 113, and the fluid chamber 113 is subsequently enlarged.

Next, a nozzle 114 is formed by sequentially etching the hydrophobic polymer layer 150, the metal layer 140, the passivation layer 130 and the structural layer 112. The nozzle 114 is adjacent to the bubble generator 120 communicating with the fluid chamber 113.

As illustrated, embodiments of the invention provide a fluid injector 100 with a composite layer comprising a metal layer 140 and a hydrophobic polymer layer 150. The metal layer 140 may substantially strengthen the fluid injector, thermally dissipating residual heat, thereby increasing operating frequency. The hydrophobic polymer layer 150 with hydrophobic surface characteristic can prevent fluid remaining on the surface of nozzles, resulting in consistent injection and stabilizing droplet escape.

### Second Embodiment

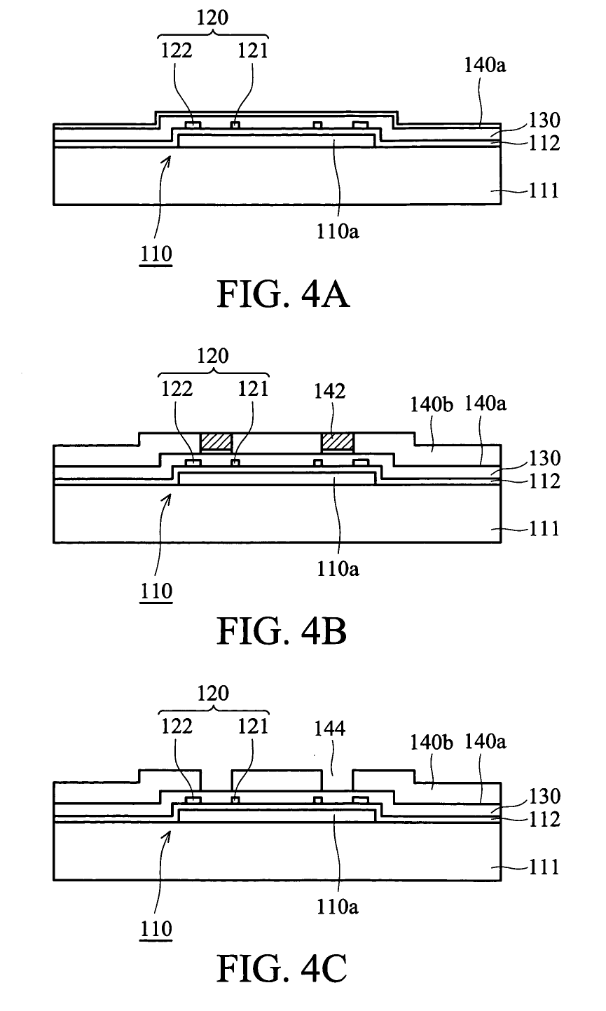

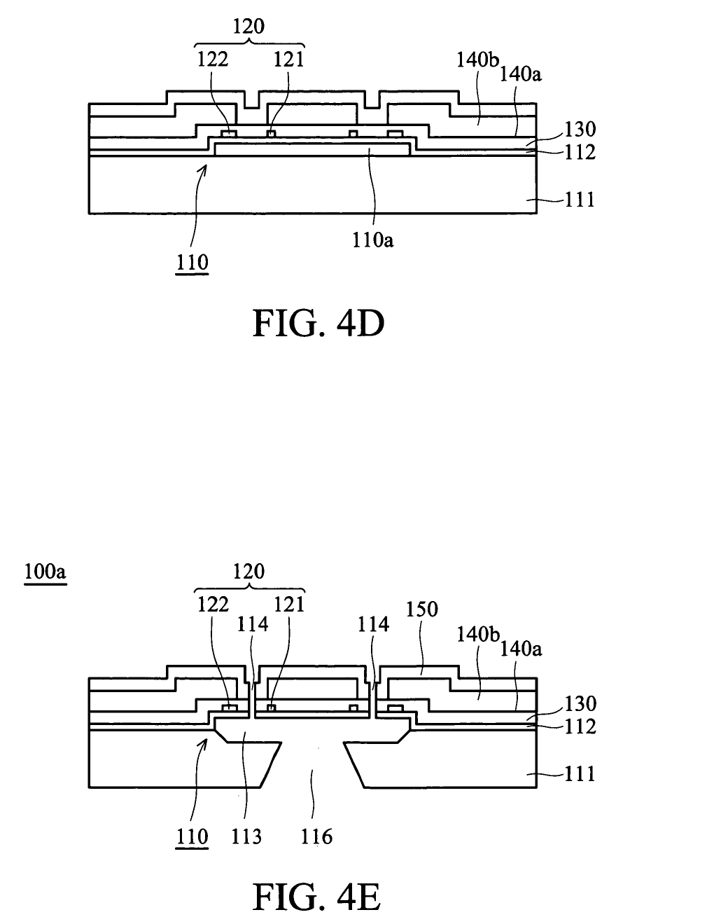

FIGS. 4A to 4E are cross-sections of the process of manufacturing a fluid injection device 110a according to the second embodiment of the invention. A base 110 is provided comprising a silicon substrate 111, a sacrificial layer 110a, a structural layer 112 disposed on the substrate 111, at least one bubble generator 120 disposed on the structural layer 112, and a passivation layer 130 disposed on the structural layer 112 covering the bubble generator 120. The fabricating steps of the base 110 in the second embodiment are nearly identical to those of the base in the first embodiment (as shown in FIG. 3A through 3C) and for simplicity, their detailed description is omitted.

Referring to FIG. 4A, an initial layer 140a is conformably formed on the base 110. The initial layer 140a (e.g. seed layer 140a) is beneficial for excellent adhesion between the subsequently formed metal layer 140b and the passivation layer 130.

Referring to FIG. 4B, a patterned photoresist 142 is lithographically formed on the initial layer 140a. As illustrated, the patterned photoresist 142 is adjacent to the bubble generator 120. A metal layer 140b is subsequently formed on the exposed initial layer 140a, preferably by electroforming or electro-less plating. The metal layer 140b comprises Ni, Ni—Co alloy, Au, Au—Co alloy or combinations thereof, and more preferably with high thermal dissipation coefficient.

Referring to FIG. 4C, the patterned photoresist 142 and the underlayer initial layer 140a are removed, thereby forming an opening 144 in the metal layer 140b. The opening 140 is located corresponding to the predetermined site of the nozzle 114 as shown in FIG. 2 and with larger diameter.

Referring to FIG. 4D, a hydrophobic polymer layer 150 is conformably formed on the metal layer filling the opening 144. The hydrophobic polymer layer 150 comprises polyimide, photosensitive polymer, or silicone, preferably formed by spin-on coating, screen printing, or rolling.

Referring to FIG. 4E, the back of the substrate 111 is etched forming a fluid channel 116 in the substrate 111 and exposing the sacrificial layer 110a. The sacrificial layer 110a is removed forming a fluid chamber 113, and the fluid chamber 113 is subsequently enlarged.

Next, a nozzle 114 is formed by sequentially etching the hydrophobic polymer layer 150, the metal layer 140b, the passivation layer 130 and the structural layer 112. The nozzle 114 is adjacent to the bubble generators 120, communicating with the fluid chamber 113.

### Third Embodiment

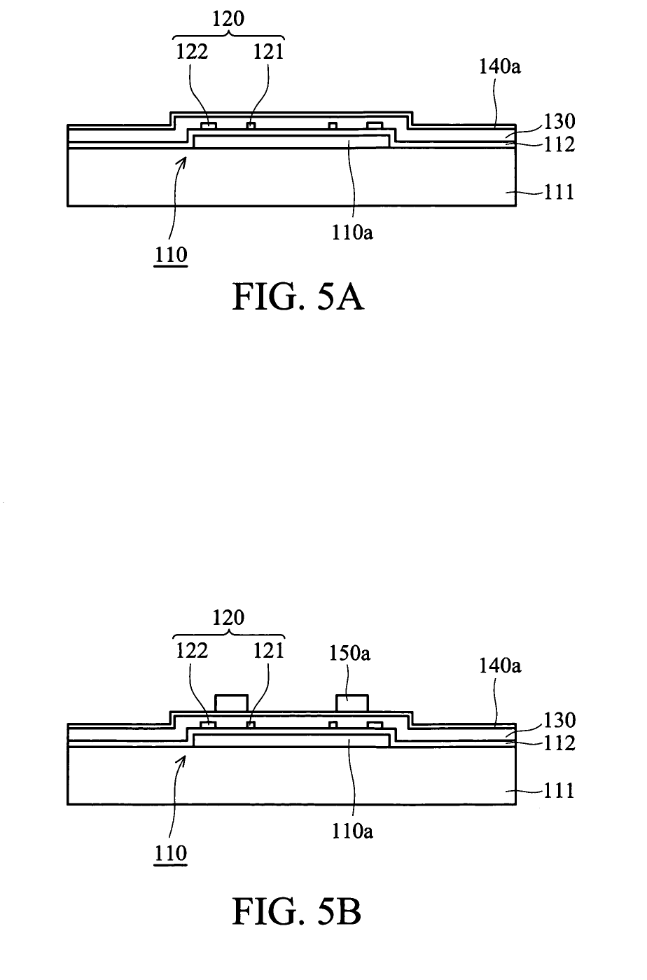

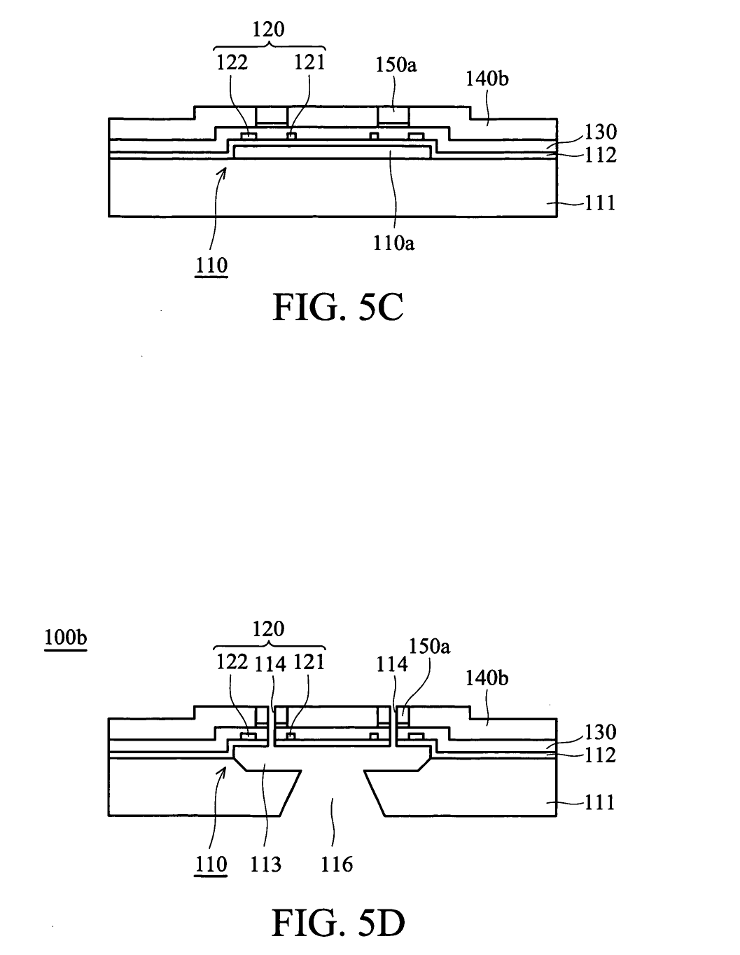

FIGS. 5A to 5D are cross-sections of the process of manufacturing a fluid injection device 100b according to the third embodiment of the invention. A base 110 is provided comprising a silicon substrate 111, a sacrificial layer 110a, a structural layer 112 disposed on the substrate 111, at least one bubble generator 120 disposed on the structural layer 112, and a passivation layer 130 disposed on the structural layer 112 covering the bubble generator 120. The fabricating steps of the base 110 in the third embodiment are nearly identical to those of the base in the first embodiment (as shown in FIG. 3A through 3C) and for simplicity, their detailed description is omitted.

Referring to FIG. 5A, an initial layer 140a is formed on the base 110. The initial layer 140a (e.g. seed layer 140a) is beneficial for excellent adhesion between the subsequently formed metal layer 140b and the passivation layer 130.

Referring to FIG. 5B, a patterned hydrophobic polymer layer 150a is formed on the initial layer 140a. The hydrophobic polymer layer 150s comprises polyimide, photosensitive polymer, or silicone, preferably formed by spin-on coating, screen printing, or rolling. The patterned hydrophobic polymer layer 150a is adjacent to the bubble generator 120, located corresponding to the predetermined site of the nozzle 114 as shown in FIG. 2 and having a larger diameter.

Referring to FIG. 5C, a metal layer 140b is subsequently formed on the exposed initial layer 140a, preferably by electroforming or electro-less plating. The metal layer 140b may also comprise Ni, Ni—Co alloy, Au, Au—Co alloy or combinations thereof, more preferably having high thermal dissipation coefficient.

Referring to FIG. 5D, the back of the substrate 111 is etched forming a fluid channel 116 in the substrate 111 and exposing the sacrificial layer 110a. The sacrificial layer 110a is removed forming a fluid chamber 113, and the fluid chamber 113 is subsequently enlarged.

Next, a nozzle 114 is formed by sequentially etching the hydrophobic polymer layer 150, the initial layer 140a, the passivation layer 130 and the structural layer 112. The nozzle 114 is adjacent to the bubble generator 120, communicating with the fluid chamber 113.

### Fourth Embodiment

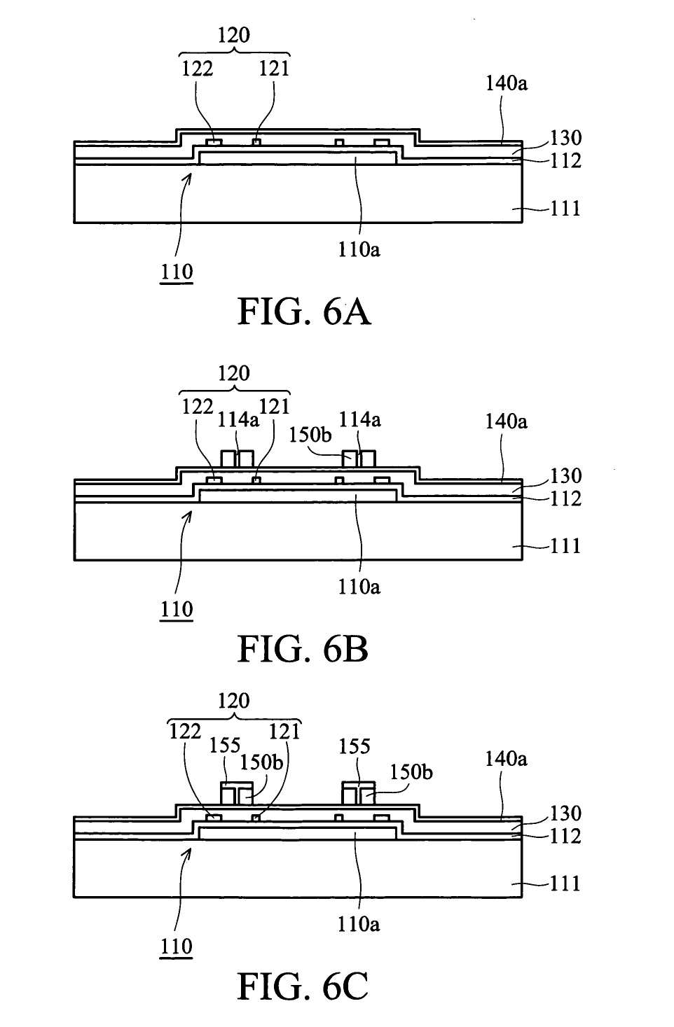

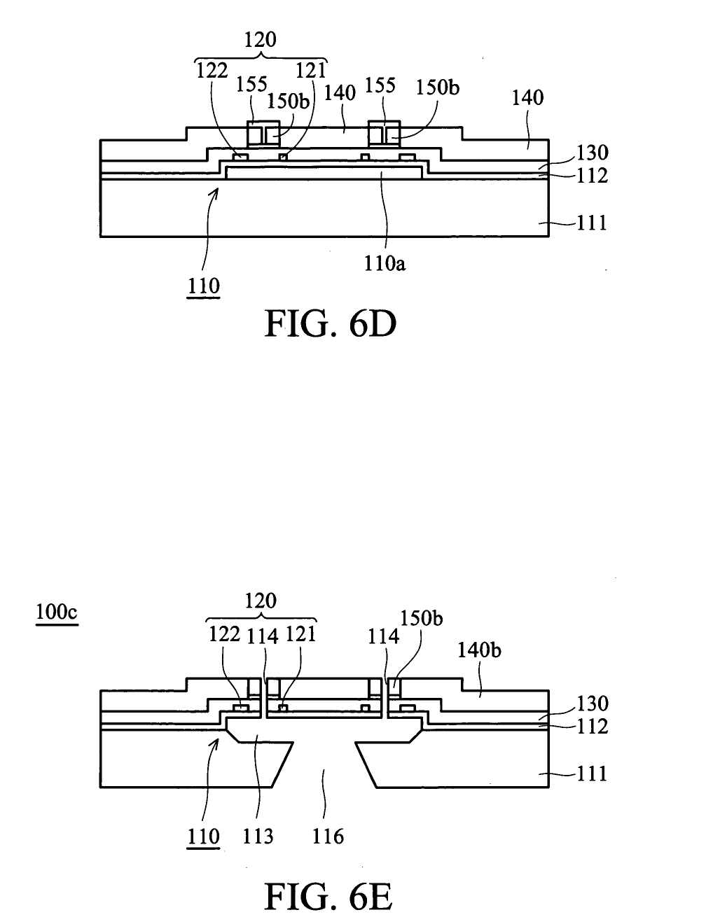

FIGS. 6A to 6E are cross-sections of the process of manufacturing a fluid injection device 100c according to the fourth embodiment of the invention. A base 110 is provided comprising a silicon substrate 111, a sacrificial layer 110a, a structural layer 112 disposed on the substrate 111, at least one bubble generator disposed on the structural layer 112, and a passivation layer 130 disposed on the structural layer 112 covering the bubble generator. The fabricating steps of the base 110 in the fourth embodiment are nearly identical to those of the base in the first embodiment (as shown in FIG. 3A through 3C) and for simplicity, their detailed description is omitted.

Referring to FIG. 6A, an initial layer 140a is formed on the base 110. The initial layer 142a (e.g. seed layer 140a) is beneficial for excellent adhesion between the subsequently formed metal layer 140b and the passivation layer 130.

Referring to FIG. 6B, a doughnut-shaped hydrophobic polymer layer 150b is formed on the initial layer 140a adjacent to the bubble generator 120. As illustrated, the doughnut-shaped hydrophobic polymer layer 150b comprises polyimide, photosensitive polymer, or silicone, preferably formed by spin-on coating, screen printing, or rolling. The doughnut-shaped hydrophobic polymer layer 150b comprises a central opening 114a corresponding to the predetermined site of the nozzle 114 as shown in FIG. 2 and having a larger diameter.

Referring to FIG. 6C, a patterned photoresist 155 is formed on the doughnut-shaped hydrophobic polymer layer 150b covering the central opening 114a thereof.

Referring to FIG. 6D, a metal layer 140b is formed on the exposed initial layer 140a surrounding the doughnut-shaped hydrophobic polymer layer 150b, preferably by electroforming or electro-less plating. The metal layer 140b may also comprise Ni, Ni—Co alloy, Au, Au—Co alloy or combinations thereof, and more preferably having high thermal dissipation coefficient.

Referring to FIG. 6E, the patterned photoresist 155 is removed, leaving an opening 114a in the center area of the doughnut-shaped hydrophobic polymer layer 150. The back of the substrate 111 is etched, forming a fluid channel 116 in the substrate 111 and exposing the sacrificial layer 110a. The sacrificial layer 110a is removed forming a fluid chamber 113, and the fluid chamber 113 is subsequently enlarged.

Next, a nozzle 114 is formed by sequentially etching the initial layer 140, the passivation layer 130 and the structural layer 112. The nozzle 114 is adjacent to the bubble generator 120, communicating with the fluid chamber 113.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A fluid injection device, comprising:
a substrate;
a structural layer disposed on the substrate;
a fluid chamber between the substrate and the structural layer;
at least one bubble generator disposed on the structural layer and on the opposite side of the fluid chamber;
a passivation layer disposed on the structural layer covering the bubble generator;
a composite layer formed on the passivation layer; and
a nozzle neighboring the bubble generator and passing through the composite layer, the passivation layer, and the structural layer communicating the fluid chamber.

2. The fluid injection device as claimed in claim 1, wherein the bubble generator comprises resistive heaters.

3. The fluid injection device as claimed in claim 2, wherein the resistive heaters comprise:
a first heater disposed on the structural layer outside the fluid chamber to generate a first bubble in the fluid chamber; and
a second heater disposed on the structural layer outside the fluid chamber to generate a second bubble in the fluid chamber.

4. The fluid injection device as claimed in claim 1, wherein the structural layer comprises silicon nitride or silicon oxynitride.

5. The fluid injection device as claimed in claim 1, wherein the composite layer comprises:
a metal layer disposed on the passivation layer; and
a hydrophobic polymer layer disposed on the metal layer.

6. The fluid injection device as claimed in claim 5, wherein the metal layer comprises Ni, Ni—Co alloy, Au, Au—Co alloy, or a combination thereof.

7. The fluid injection device as claimed in claim 5, wherein the hydrophobic polymer layer comprises polyimide, photosensitive polymer, or silicone.

8. The fluid injection device as claimed in claim 1, wherein the composite layer comprises:
a metal layer disposed on the passivation layer with an opening; and
a hydrophobic ploymer layer formed conformably on the metal layer and the passivation layer, filling the opening.

9. The fluid injection device as claimed in claim 1, wherein the composite layer comprises:
a metal layer disposed on the passivation layer with an opening; and
a hydrophobic polymer layer disposed on the substrate in the opening.

10. A method for fabricating a fluid injection device, comprising the steps of:
providing a substrate;
forming a patterned sacrificial layer on the substrate;
forming a patterned structural layer on the substrate covering the sacrificial layer;
forming at least one fluid actuator on the structural layer;
forming a passivation layer on the structural covering the fluid actuator;
forming a composite layer on the passivation layer;
removing a portion of the bottom of the substrate, creating a fluid channel in the substrate and exposing the sacrificial layer;
removing the sacrificial layer to form a fluid chamber; and
sequentially etching the composite layer, the passivation layer, and the structural layer to create a nozzle neighboring the fluid actuator and communicating with the fluid chamber.

11. The method as claimed in claim 10, wherein the step of forming the composite layer comprises:
forming a metal layer on the passivation layer; and
forming a hydrophobic polymer layer on the metal layer.

12. The method as claimed in claim 11, wherein the metal layer comprises Ni, Ni—Co alloy, Au, Au—Co alloy, or a combination thereof.

13. The method as claimed in claim 11, wherein the metal layer is formed by electro-forming, electroless plating, PVD, or CVD.

14. The method as claimed in claim 11, wherein the hydrophobic polymer layer comprises polyimide, photosensitive polymer, or silicone.

15. The method as claimed in claim 11, wherein the hydrophobic polymer layer is formed by spin-on coating, screen printing, or rolling.

16. The method as claimed in claim 10, wherein the step of forming the composite layer comprises:
forming a metal layer on the passivation layer with an opening; and
forming a hydrophobic polymer layer conformably on the metal layer and the passivation layer, filling the opening.

17. The method as claimed in claim 10, wherein the step of forming the composite layer comprises:
forming a metal layer on the passivation layer with an opening; and
forming a hydrophobic polymer layer on the substrate in the opening.
